(19) United States
(12) Patent Application Publication
(10) Pub. No.: US 2002/0120355 A1
(43) Pub. Date: Aug. 29, 2002

(54) Audio-video processing system and computer-readable recording medium on which program for implementing this system is recorded

(76) Inventor: Yoichi Tanaka, Tokyo (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/122,211

(22) Filed: Apr. 16, 2002

Related U.S. Application Data
(63) Continuation of application No. PCT/JP99/05815, filed on Oct. 21, 1999.

(51) Int. Cl. H04R 5/00; G06F 17/00

(52) U.S. Cl. 700/94; 381/1

(57) ABSTRACT

This audio-video processing system reproduces downloaded audio data to be a model into audio signals and downloaded video data to be a model into video signals. In this audio-video processing system, audio signals collected by microphone 10 are fetched by audio input processing means (S432a). Audio data to be a model is also downloaded in advance. An audio output processing means reproduces this model audio data into audio signals and places these signals on one channel (S433a). The audio output processing means is capable of placing the audio signals from the audio input processing means on another channel (S433a).

### TECHNICAL FIELD

The present invention relates to an audio-video processing system that is suitably used, for example, for learning foreign language conversation, for teaching young children, or for singing practice, and a computer-readable recording medium on which a program for implementing this system is recorded.

### BACKGROUND ART

It is common knowledge that the recent development of electronic technology has resulted in marked improvement in personal computer (hereinafter, referred to simply as computer) performance and that computers can be purchased cheaply. Therefore, various audio-video processing systems that use computers, such as systems for learning foreign language conversation, for teaching young children, and for practising singing, have been proposed.

Such audio-video processing systems comprise computer apparatus hardware and software in the form of an audio-video processing program that provides the system. Here, the above computer apparatus comprises: an input unit; a monitor; sound apparatus; and a computer that stores the audio-video program providing this system, that processes the audio-video processing program in accordance with prompts from input apparatus, and that sends required information to the sound apparatus and monitor. The sound apparatus comprises: a sound board within the actual computer or a sound card installed in the computer; left and right speakers (headphones) that convert acoustic output signals from the sound board or sound card into sound; and a microphone that sends sound to the sound board or sound card as a acoustic input signals. Furthermore, the audio-video processing program that provides this system comprises an operating system for the basic operations between the system and the computer and an application program that manages the specific operations of the system.

In such conventional audio-video processing systems, the model audio data downloaded into the computer is reproduced into audio signals and model video data is reproduced into video signals. By sending the video signals to the above monitor and the audio signals to the above sound apparatus, the video is shown on the monitor at the same time as the sound is reproduced from the speakers in the above sound apparatus.

Thus, a user obtains the desired video, and also the sound effects or the prescribed foreign language together with the video.

Accordingly, the reproduction method used in the above conventional audio-video processing system is ideally suited for use when a user simply wishes to passively watch video or listen to audio.

### PROBLEMS TO BE SOLVED BY INVENTION

However, in conventional audio-video processing systems, when a user must participate in the execution of this program, such as when a user is learning a foreign language or practising singing, both the sounds being produced by the user and the audio being reproduced from the speakers (or headphones) are heard by both ears of the user simultaneously, producing the following problems.

(1) Audio reproduced from an audio-video processing system and sound produced by a user are heard by both user's ears simultaneously. The sound mixes together and can cause confusion in the brain that is unable to organise the sounds. This means that adequate learning or practice is impossible.

(2) Also, at the same time that a user is listening to sounds being reproduced by this audio-video processing system, they must produce sound while following text, or letters or symbols displayed on the system monitor and listen to the sounds they produce. This causes confusion.

The present invention aims to eliminate the defects of the above conventional systems and provide an audio-video processing system that improves learning and a recording medium that can be read by a computer with a program that provides the system being recorded thereon.

### DISCLOSURE OF THE INVENTION

The audio-video processing system according to the present invention, which regenerates downloaded model audio data into audio signals and downloaded model video data into video signals, comprises: an audio input processing means that receives audio signals via a microphone; and an audio-output processing means that regenerates the above model audio data into audio signals for one channel and that makes audio signals from the above audio input processing means become the audio signals for another channel. This enables the model audio to be heard in one ear and the audio produced by the user to be heard in the other ear. This enables the foreign language learning or singing practice to be carried out without confusion.

Also, the audio-video processing system according to the present invention, which regenerates downloaded model audio data into audio signals and downloaded model video data into video signals, comprises an audio input processing means that receives audio signals via a microphone; an audio output processing means that regenerates the above model audio data into audio signals for one channel and makes the audio signals from the above audio input processing means become the audio signals for another channel; and a sound level adjustment means that adjusts the sound levels of both above channels. This means that the model audio and sound produced by the user are heard separately by different ears. Further, because the sound levels are the same for both, proper foreign language learning or singing practice can be done without confusion.

The present invention further comprises a recording medium, an audio input processing file, which receives audio signals via a microphone, and an audio output processing file, which regenerates the above model audio data into audio signals for one channel and makes the audio signals from the above audio input processing file become the audio signals for another channel, being recorded thereon. It is possible to provide an audio-video processing system at any time in a computer by circulating this recording medium.

### BRIEF DESCRIPTION OF THE DRAWINGS

FIG. 1 is a block diagram showing computer apparatus that provides a pleasant audio-video processing system according to the present invention;

FIG. 2 explains the relationship between the hardware and software that provide this audio-video processing system;

FIG. 3 is a flowchart that shows an example of the overall operation of this audio-video processing system;

FIG. 4 is a flowchart that shows an example of various setting operations in this audio-video processing system;

FIG. 5 is a flowchart that explains an example of a specific operation in this audio-video processing system;

FIG. 6 explains specific examples of audio and video reproduction in this audio-video processing system;

FIG. 7 explains an example of foreign language conversation learning using this audio-video processing system;

FIG. 8 is a block diagram showing an example of singing practice using this audio-video processing system; and

FIG. 9 explains an example of singing practice using this audio-video processing system.

### BEST MODE FOR CARRYING OUT THIS INVENTION

The embodiment of the present invention will be explained, using figures for reference.

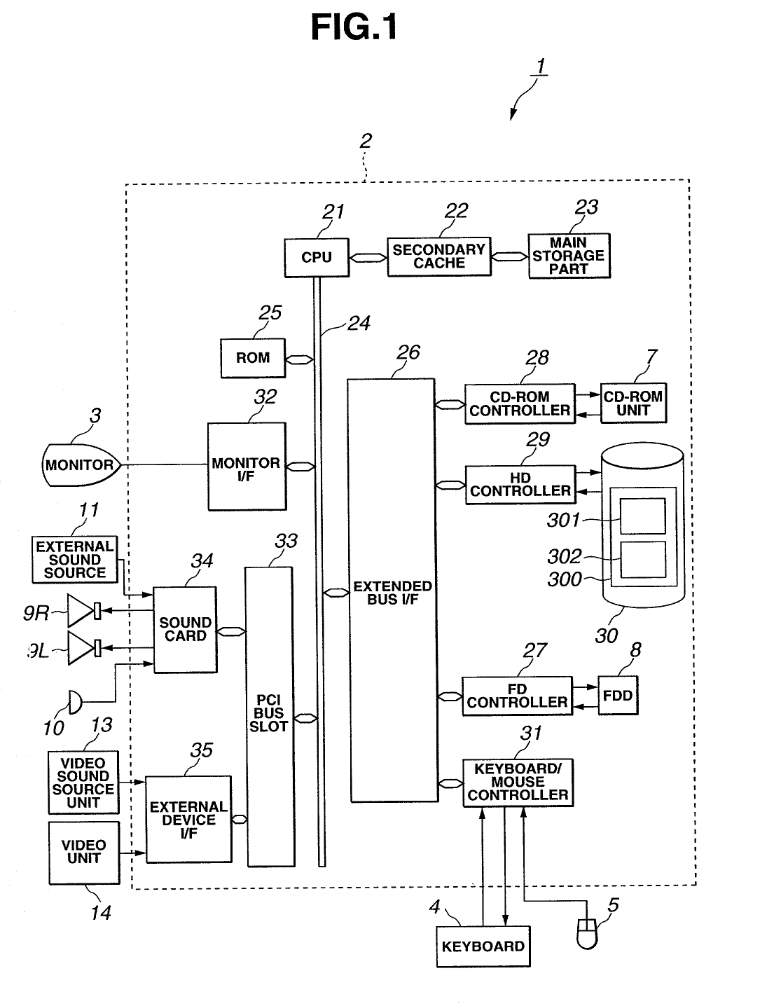

FIGS. 1 through 7 show an audio-video processing system according to a first aspect of the embodiment of the present invention;

Computer apparatus 1 shown in FIG. 1 can be configured, for example, as a personal computer and comprises: the computer 2 that executes various processing; a display means (monitor) 3 for displaying display data from computer 2; a keyboard 4 that directly inputs the information required for various processing using letters, numbers, and symbols; and a mouse 5 that inputs data via the screen of monitor 3 in the execution of various processing. Computer 2 comprises a CD-ROM driver 7 that reads CD-ROMs and a floppy disk driver (FDD) 8. Acoustic output signals are supplied from this computer 2 to left and right speakers (or headphones) 9L and 9R. The computer 2 is supplied with audio input signals from microphone 10 and external sound source apparatus 11. Computer 2 is also supplied with a video acoustics input signals and video input signals from video sound source apparatus 13, such as a digital video deck (DVD) or video tape recorder, or from video apparatus 14 that supplies only video, such as a digital camera.

Furthermore, the above computer 2 is also equipped with the following: central processing unit (CPU) 21 that executes various arithmetic processing and has a primary cache memory; a secondary cache memory 22 referred to by this CPU 21; a main storage part 23 connected to CPU 21 via this second cache memory 22; ROM 25 connected to CPU 21 via bus line 24; extended bus interface (extended bus I/F) 26 connected to CPU 21 via bus line 24; floppy disk (FD) controller 27 connected to this extended bus I/F 26; CD-ROM controller 28 connected to this extended bus I/F 26; hard disk (HD) controller 29 connected to this extended bus I/F 26; hard disk storage unit 30 connected to this HD controller 29; keyboard/mouse controller 31 connected to the above extended bus I/F 26; monitor interface (monitor I/F) 32 connected to the above bus line 24; a sound card 34 installed, for example, in the peripheral component interconnect (PCI) bus slot 33; and an external device interface (I/F) 35, such as a small computer system interface (SCSI), installed in the above bus slot 33. In this aspect of the embodiment, it is obviously also possible not to use a sound card system, but to connect a sound board to bus line 24, to provide speaker terminals and a microphone terminal on the sound board, and to connect speakers or headphones and a microphone.

Here, a keyboard 4 and mouse 5 are connected to keyboard/mouse controller 31. A CD-ROM driver 7 is connected to CD-ROM controller 28. A hard disk storage unit 30 is connected to HD controller 29. A monitor 3 is connected to monitor I/F 32. Left and right speakers 9L and 9R are connected to the output terminals of sound board 33 and microphone 10 or external sound source apparatus 11 is connected to the input terminal of sound board 33. Video sound source apparatus 13 and video apparatus 14 are connected to external device I/F 35.

Audio-video processing program 300, this audio-video processing system being provided therewith, is stored in hard disk storage unit 30. This audio-video processing program 300 includes an operating system 301, such as Windows 98 or Windows NT that executes the basic operations between the program and the computer, and an application program 302 that manages the specific operations of this audio-video processing system.

When power is turned on for computer 2 in computer apparatus 1 thus configured, CPU 21 in computer 2 executes the initial processing in accordance with an initial processing program, such as BIOS, stored in ROM 25. The CPU 21 then opens and stores in main storage part 23 the audio-video processing program 300 (operating system 301 and application program 302) stored in hard disk storage unit 30. Thereafter, the audio-video processing system is provided by executing the audio-video processing program 300 after opening it from main storage part 23.

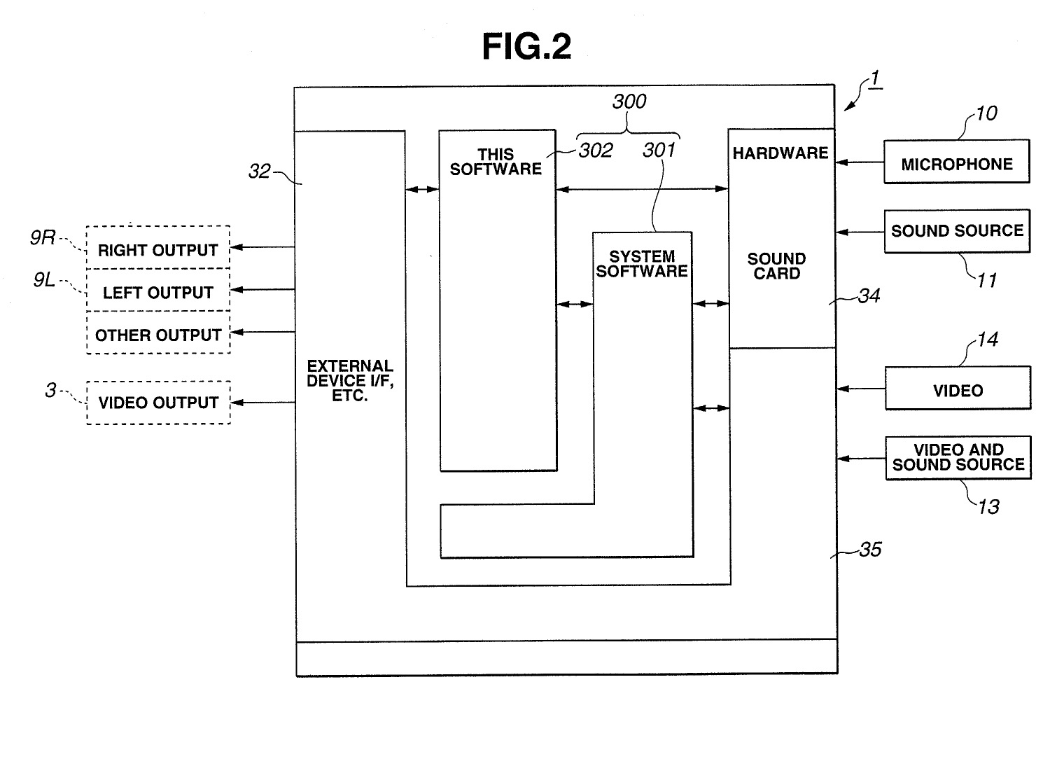

FIG. 2 shows the relationship between hardware, such as computer apparatus 1, and the audio-video processing program 300 executed. In FIG. 2, the operation system 301 in audio-video processing program 300, which is executed in CPU 21 of computer 2, executes the application program 302 in audio-video processing program 300 and controls sound card 34, external device I/F 35, and monitor I/F 32. This enables incorporation of video acoustic input signals from video sound source apparatus 13 and video input signals from video apparatus 14. It is also possible to send video output signals to the monitor and the required acoustic output signals to speakers 9L and 9R.

Application program 302 in audio-video processing program 300 also receives acoustic input signals from microphone 10 and external sound source apparatus 11 via sound card 34. It then processes these signals and sends acoustic output signals to speakers 9L and 9R and a video output signal to monitor 3.

The computer 2 and audio-video processing program 300 thus provide the audio-video processing system.

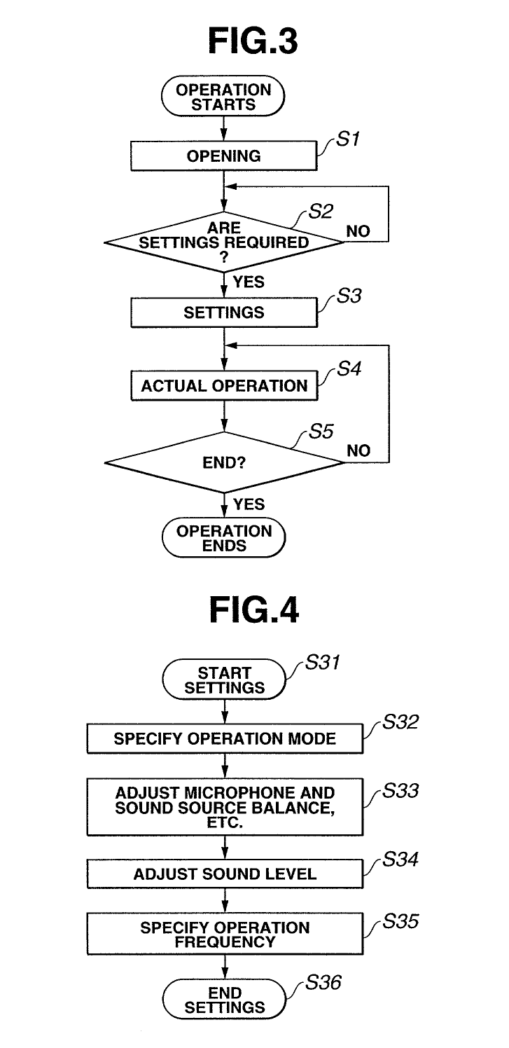

The actions of an embodiment configured as above will be explained based on FIGS. 1 and 2 and referring to FIGS. 3 and beyond.

FIG. 3 is a flowchart that explains the operations in a specific example in which the system is used for learning foreign language conversation. When the power is turned on and a command received to execute application program 302, CPU 21 of computer 2 starts execution of the flowchart shown in FIG. 3.

The CPU 21 firstly executes application program 302 then executes opening processing (S1). This causes an opening screen to be displayed on monitor 3 and an introductory message to be reproduced from speakers 9L and 9R.

Next, CPU 21 creates video signals for a prompt screen and prompt acoustic signals that ask whether or not operation mode, left and right speaker 9L and 9R sound balance, and sound level adjustment settings are required. These signals are sent to monitor 3 via monitor I/F 32 and to sound card 34 (S2). This causes a settings prompt screen to be displayed on monitor 3 and prompt audio to be reproduced from speakers 9L and 9R.

When CPU 21 detects that the user has used keyboard 4 or mouse 5 to indicate that settings are required (S2; YES), the computer 2 executes various settings operations (S3).

When settings are not required because the previous settings will be used, the user enters that fact into computer 2 using the keyboard 4 or mouse 5. Computer 2 then determines that settings are not required (S2; NO), skips settings processing, and proceeds to the next step (S4).

When settings operations end (S3) or when settings are not required (S2; NO), computer 2 executes application program 302 to provide the audio-video processing system (S4). Computer 2 then creates video signals and audio signals for a prompt screen asking whether or not to end application program 302 after it has operated a prescribed number of times. These signals are provided to monitor I/F 32 and sound card 34 (S5). The end prompt screen is reproduced on monitor 3 and the end prompt audio from speakers 9L and 9R.

Here, when the user uses a keyboard 4 or mouse 5 to input into computer 2 the fact that they have selected end, CPU 21 determines that end has been selected (S5; YES) and ends the flowchart shown in FIG. 3.

On the other hand, when the user uses a keyboard 4 or mouse 5 to input into computer 2 the fact that operations will not end, CPU 21 determines that end has not been selected (S5; NO) and returns to the step (S2) in which the video and audio signals for the prompt screen that asks whether or not settings are required are created and output.

FIG. 4 is a flowchart for explaining settings operations in this audio-video processing system. These operations are subroutines of processing step (S3) of FIG. 3.

When the CPU 21 of computer 2 moves to the processing involved in S3 of FIG. 3, it enters the operation to start settings (S31). CPU 21 then creates audio and a screen for specifying the operation mode and implements processing to gather required information (S32). CPU 21 then implements processing to adjust the balance of microphone 10 or sound source (S33). Next, CPU 21 implements processing to adjust the volume of the left and right speakers 9L and 9R (S34) and to process settings for the frequency with which an operation should occur (S35). It then ends the settings operation (S36).

When settings processing is completed as above, the environment in which the audio-video processing system operates is complete.

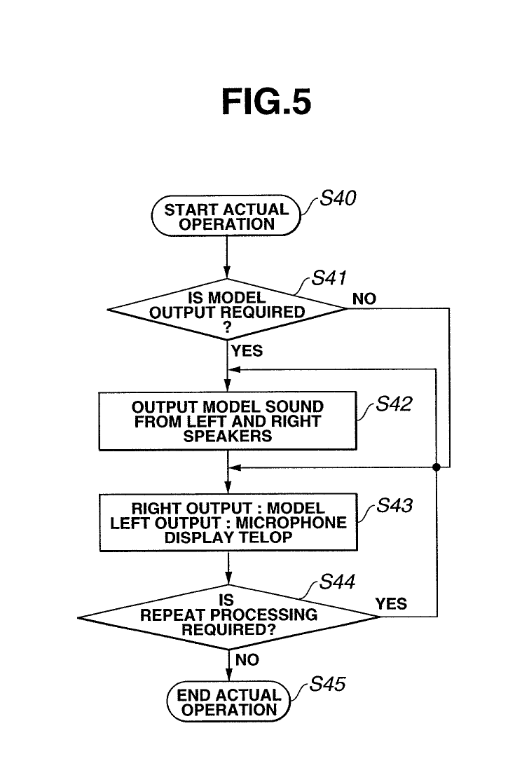

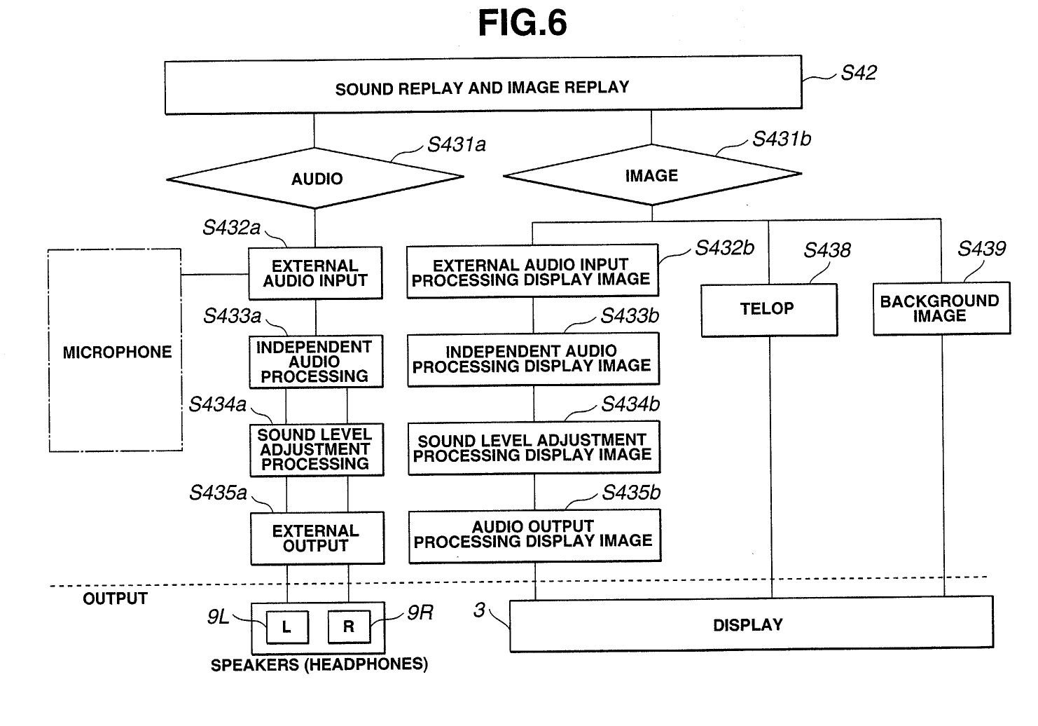

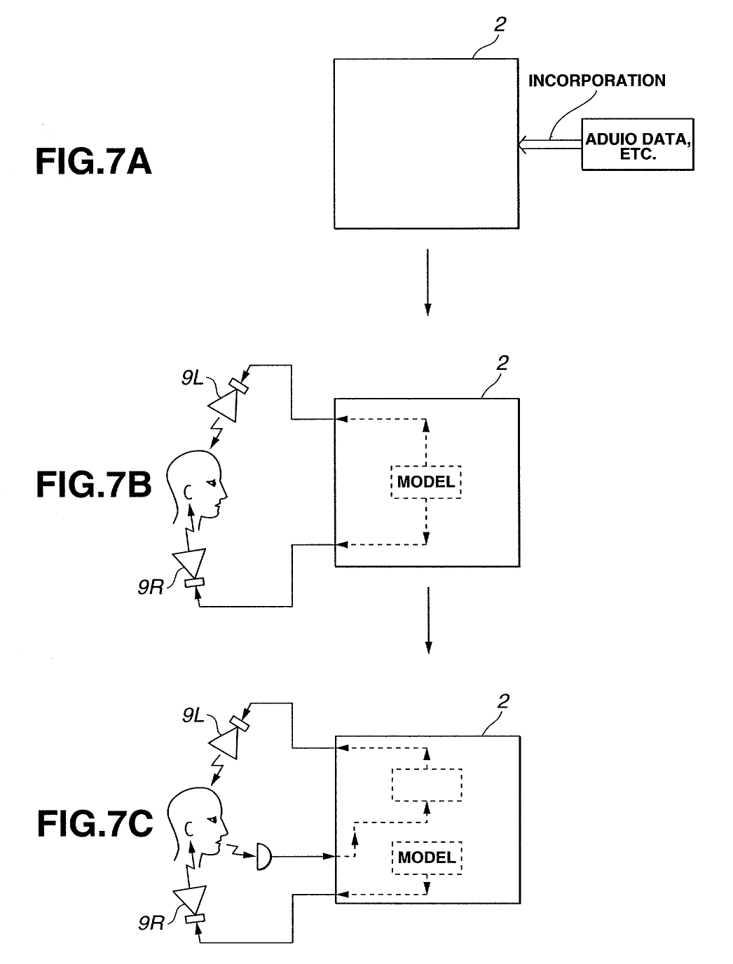

Now specific operation of the audio-video processing system will be explained with reference to the flowchart in FIG. 5. FIG. 6 is a subroutine of a step in FIG. 5 and is a flowchart for explaining a specific example of audio and video reproduction. Here, reference will be made to the figure explaining operations in FIG. 7.

When CPU 21 executes step (S4) of FIG. 3, computer 2 downloads the audio-video data stored in hard disk storage unit 30, the audio-video data stored in the CD-ROM set in CD-ROM driver 7, or the audio-video data from the video sound source apparatus 13, and prepares for reproduction by executing certain processing. (S40 in FIG. 5. Refer to FIG. 7(a).)

Next, CPU 21 creates video and audio signals for a prompt screen that asks whether or not sample output is required. These signals are sent to, monitor 3 via monitor I/F 32 and to speakers 9L and 9R via sound card 34 (S41). This enables monitor 3 to display a screen that asks whether or not sample output is required and at the same time, reproduces prompt audio from speakers 9R and 9L.

Assume now that as a user looks at the prompt screen displayed on this monitor 3 and listens to the prompt audio from speakers 9L and 9R, they use keyboard 4 or mouse 5 to tell the computer 2 that sample output is required.

Thereupon, CPU 21 detects that samples are required (S41; YES). It creates video signals for the sample image and sends these to monitor I/F 32, creates acoustic signals for the Model audio and sends these to sound card 34 (S42). This causes the model image to be displayed on monitor 3 and the model audio signal to be reproduced from left and right speakers 9L and 9R. Accordingly, the model audio from left and right speakers 9L and 9R enters both ears of the user (refer to FIG. 7(b)).

Next, CPU 21 executes repeat processing (S43). When this repeat processing is entered into (S431a and S431b in FIG. 6), CPU 21 executes audio input processing from microphone 10 (S432a). CPU 21 then creates video signals for the external audio input processing display image and sends these to monitor I/F 32 (S431b). This causes an external audio input processing display screen to be displayed on monitor 3.

CPU 21 next executes processing to set and control sound card 34 so that audio signals from microphone 10 are output from, for example, the left speaker 9L and the model audio signals are output from right speaker 9R (so that the audio signals from each channel are processed independently) (S433a). CPU 21 then creates video signals for an independent audio processing display screen and sends them to monitor I/F 32 (S433b). This results in the independent audio processing display screen being displayed on monitor 3. When model audio signals are output from right speaker 9R and the model audio signals are stereo, the left and right audio channels are synthesized and the signals converted into one-channel audio signals. They are then sent to one channel of sound card 34. Thus, CPU 21 provides an audio input processing means. This audio input processing means is used to receive audio from microphone 10 CPU 21 also provides an audio output processing means. This audio output processing means is used to output audio signals from microphone 10 to, for example, left speaker 9L and to output model audio signals from right speaker 9R.

CPU 21 adjusts the sound level of sound card 34 so that its reaches the sound level set in the flowchart of FIG. 4 (S434a). It creates the video signals for the sound level adjustment processing display image and sends it to monitor I/F 32 (S434b). This then causes a sound level adjustment processing display screen to be displayed on monitor 3.

CPU 21 then outputs model audio signals to sound card 34 from, for example, right speaker 9R and audio signals from microphone 10 from left speaker 9L. These audio signals are sent to sound card 34 so that they can be output externally (S435a). CPU 21 then creates video signals for an audio output processing display screen (S435a). In other words, CPU 21 creates video signals that change the colour of letters to show which letters in which current word the model audio signal is pronouncing. These video signals are then sent to monitor I/F 32 (S435a). This means that the user of this system can accurately confirm the part that is being pronounced in the model and also confirm how well they are pronouncing that part.

Accordingly, while the right ear of the user using this system can hear the model audio, the left ear can hear the user's own voice (refer to FIG. 7(c)).

As a result, a user can properly distinguish between the model audio and their own voice without confusion and therefore learn foreign language conversation more accurately.

Video signals for a telop image (S438) or video signals for a background image (S439) are also created in CPU 21 of the above computer 2 and sent to monitor I/F 32. This enables telop images or background screens required in repeat processing to be displayed on monitor 3.

When such processing ends, CPU 21 creates video signals for a prompt screen that asks whether or not repeat processing is required and sends them to monitor I/F 32. In addition it creates prompt audio and sends that to sound card 34 (S44). This causes a screen that asks whether or not repeat processing will be implemented to be displayed on monitor 3 and prompt audio to be reproduced from speakers 9R and 9L.

When a user uses keyboard 4 or mouse 5 to input into the computer 2 that repeat processing is not necessary, CPU 21 detects this (S44; NO) and ends processing (S45).

On the other hand, when a user uses keyboard 4 or mouse 5 to input into the computer 2 that repeat processing is not necessary, CPU 21 moves to step (S42) and starts processing to move to step 42.

Also, in step 41, when model output is not required (S41; NO), CPU 21 executes the processing involved in step 43.

According to the first aspect of the embodiment of the present invention as described above, model audio enters one ear while a user's own voice enters the other ear. This enables a user to properly distinguish between the model audio and their own voice. The brain is not confused and thus a user is more easily able to learn foreign language conversation.

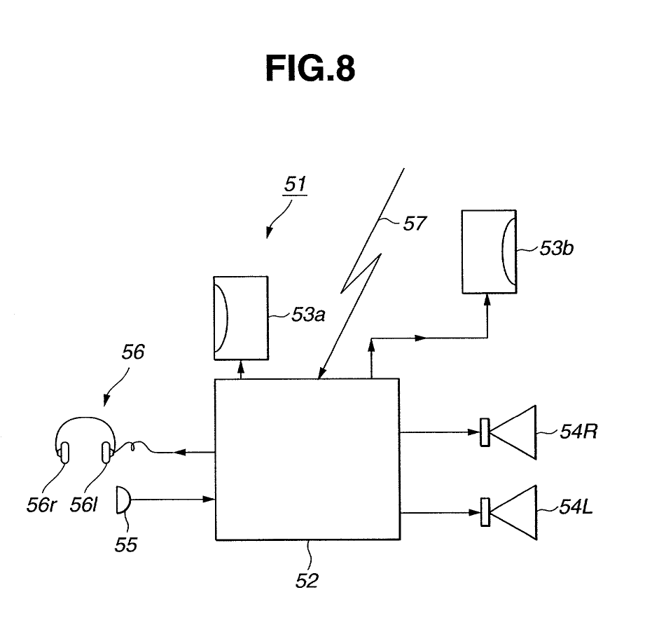

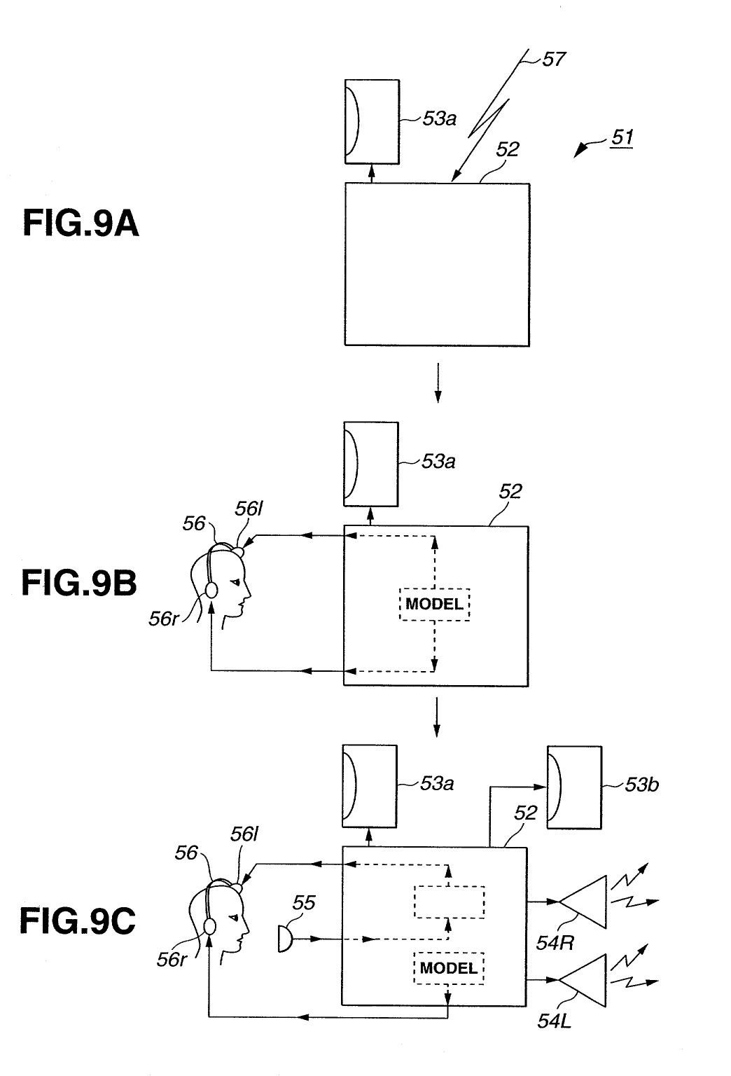

FIGS. 8 and 9 explain an audio-video processing system according to a second embodiment. These figures will be explained using a specific example of singing practice.

Karaoke apparatus 51, this audio-video processing system being applied therein, comprises karaoke processing unit 52, monitors 53a and 53b, speakers 54L and 54R, microphone 55, and headphones 56. Karaoke processing unit 52 comprises almost exactly the same elements as the first aspect of the embodiment but also includes a communication unit (not pictured) that can communicate with the outside via communication lines 57. This karaoke processing unit 52 is configured so that music data for karaoke is downloaded from the outside via the aforementioned communication apparatus and communication lines 57. (Naturally, the music data can be downloaded and reproduced using various media, including laser disks and DVDs.)

Furthermore, karaoke processing unit 52 sends downloaded music data to a sound board, not pictured, or sends audio data collected from a microphone 55 to the sound board.

Karaoke processing unit 52 further executes repeat processing for the sound board. It can send audio signals collected by microphone 55 to the left regenerator 561 of headphone 56 and the model audio signals to the right regenerator 56r of headphone 56.

Karaoke processing unit 52 also synthesises audio signals collected by microphone 55 and karaoke music data, amplifies them in the left and right channels and sends them to speakers 53L and 53R. This allows a user to hear their voice with the karaoke music.

Thus, karaoke apparatus 51 provides an audio-video processing system that operates in the same way as the first aspect of the embodiment.

In other words, the karaoke processing unit 52 of this karaoke apparatus 51, firstly executes processing to receive the music data required for singing practice (refer to FIG. 9(a)). This downloads music data from a karaoke music transmission centre (not pictured) via communication lines 56, for example.

Next, when a command is made to execute processing so the user hears only the model, the karaoke processing unit 52 executes processing that sends the music signals to both the left and right channels of the regenerators in both sides of headphones 54. This enables the user to hear the model music in both left and right ears (refer to FIG. 9(b)).

Assume now that after listening to model music in this way the user wishes to practice singing with the music. When music practice is entered into, the karaoke processing unit 52 sends the model music signals to the right regenerator in headphones 54 so that the model music enters one ear (for example, the right ear). The karaoke processing unit 52 also uses the microphone 55 to gather the sounds emitted by the user and sends these as audio signals from microphone 55 to the left regenerator in headphones 54 so that they are heard by the other ear (for example, the left ear). This enables the user of this system to, for example, hear the model music in the left ear and the sound of their own voice in their right ear (refer to FIG. 9(c)). Also, the user's singing voice is output from both speakers 53R and 53L to match the karaoke music being reproduced.

At this time, the reproducion status of the music can be made clear to the user by changing the colour of the text to suit the music or providing an arrow that shows the current portion of the text.

The karaoke processing unit 52 executes repeat processing. When processing is sending model music to the left ear, stereo music signals are synthesized into one channel and processed so that the singing voice recorded in the model music is also reproduced. Such processing enables all music information to be reproduced from the regenerator on one side of headphones 54 so that the user can practise singing properly.

Even in this second aspect of the embodiment of the present invention as described above, the model music enters one ear and the user's own voice enters the other ear. Therefore, a user can properly distinguish between the model music and their voice without any confusion being caused. Therefore, easy but accurate singing practice becomes possible and new music can be learnt in a short time.

In each of the above aspects of the embodiment, the model music enters the left ear and the sound produced by the user's voice enters the right ear. However, the present invention is not limited to this and the model music may enter the right ear and the user's voice may enter the left ear. What is important is that the model music in one ear and the user's voice in the other ear are separate but at the same level.

Also, the recording medium, the program that provides the above embodiments being recorded thereupon, can read by a computer. An audio-video processing system can be provided by incorporating onto, and executing in a computer the program that provides the above audio-video processing system recorded on this recording medium.

On this recording medium is recorded an audio input processing file that receives audio signals via a microphone, and an audio output processing file that enables the above model audio data to be reproduced into audio signals for one channel and the audio signals from the above audio input processing file to be made into audio signals for another channel.

Here, the recording medium onto which the program that provides the above embodiments is recorded can be a floppy disk, CD-ROM, photoelectromagnetic disk, RAM card with battery backup, flash memory card, non-volatile RAM card, DVD (digital video disk), magnetic tape, hard disk, or other medium. Likewise, this recording medium includes a communication medium, wired or radio.

The recording medium referred to here is a medium onto which information including programs and data is recorded by a physical means and one that is able to perform functions prescribed by a computer or dedicated processor. Accordingly, the recording medium can include any medium that installs a program into the above processing unit and fulfils the prescribed functions.

The program that provides the above system is recorded using such a recording medium. The audio-video system is achieved when this recording medium is read on a computer.

### INDUSTRIAL APPLICABILITY

The audio-video processing system according to the present invention as described above enables model music only to be heard by both ears, or enables model audio to be heard in one ear only and sounds made by a user to be heard in the other ear. This means that foreign language conversation can be learnt without confusion and singing can be practised easily. Furthermore, new music can be learnt easily.

1. An audio-video processing system which reproduces audio data to be used as a model into audio signals, and reproduces video data for use as a model into video signals, comprising:
processing means which, when said audio data to be used as the model undergoes reproduction processing, and only model sound resulting therefrom is to be transmitted to an audio channel, processes data of said model sound so as to transmit to both audio channels;
audio input processing means for receiving vocalized sound via a microphone as audio signals; and
audio output processing means which, when vocalized sound which is vocalized so as to superimpose said model sound is reproduced and is inputted into said audio input processing means, reproduces said audio data to be used as the model as audio signals to be set as the audio signals on one channel, and sets the audio signals from said audio input processing means as the audio signals on the other channel.

2. An audio-video processing system which reproduces audio data to be used as a model into audio signals, and reproduces video data for use as a model into video signals, comprising:
processing means which, when said audio data to be used as the model undergoes reproduction processing, and only model sound resulting therefrom is to be transmitted to an audio channel, processes data of said model sound so as to transmit to both audio channels;
audio input processing means for receiving vocalized sound via a microphone as audio signals; and
audio output processing means which, when vocalized sound which is vocalized so as to superimpose said model sound is reproduced and is inputted into said audio input processing means, reproduces said audio data to be used as the model as audio signals to be set as the audio signals on one channel, and sets the audio signals from said audio input processing means as the audio signals on the other channel; and
sound level adjustment means for adjusting the level of reproduced audio signals of said model sound and the level of audio signals of said vocalized sound inputted via the microphone.

3. A computer-readable recording medium on which a program is recorded to be executed by a computer, said program comprising:
processing means which, when said audio data to be used as a model undergoes reproduction processing, and only model sound is to be transmitted to an audio channel, processes data of said model sound so as to transmit to both audio channels; and
audio output processing means which, when vocalized sound which is vocalized so as to superimpose said model sound is reproduced and is inputted from audio input processing means, reproduces said audio data to be used as the model as audio signals to be set as the audio signals on one channel, and sets the audio signals obtained by receiving vocalized sound via a microphone, as the audio signals on the other channel.
